(19) United States
(12) Patent Application Publication
(10) Pub. No.: US 2005/0007519 A1
(43) Pub. Date: Jan. 13, 2005

(54) Device for controlling the polarization of a signal carried in the form of a light beam, and corresponding application

(76) Inventors: Jean-Louis De Bougrenet De La Tocnaye, Guilers (FR); Laurent Dupont, Plouzane (FR)

Correspondence Address: MERCHANT & GOULD PC, P.O. BOX 2903, MINNEAPOLIS, MN, 55402-0903, US

(21) Appl. No.: 10/499,213

(22) PCT Filed: Dec. 17, 2002
(86) PCT No.: PCT/FR02/04422

(30) Foreign Application Priority Data
Dec. 17, 2001 (FR) 01/16341

(51) Int. Cl. G02F 1/1333

(52) U.S. Cl. 349/86

(57) ABSTRACT

The invention concerns a device for controlling the polarization of a signal transported, by optical fiber, in the form of a luminous beam. According to the invention, this device comprises: a cell formed by two substrate plates essentially parallel to one another and between which is confined a contents comprising a polymer in which droplets of liquid crystal are dispersed; first application means, on at least part of the cell contents, of an electrical field more or less perpendicular to the direction of the spread of the luminous beam. so that, depending on whether the first electrical field is applied or not, at least part of the contents of the cell forms a birefringent or isotropic medium respectively.

The scope of the invention is the transmission of signals by optical fibres.

More precisely, the invention concerns a device for controlling the polarisation of a signal transported, by optical fibre, in the form of a luminous beam. An ideal polarisation controller is a birefringent plate for which it is possible to control the direction of its axes and the phase offset, and which moreover has endless control.

Such a polarisation controller is used, but not restrictively, in a system for compensating polarisation mode dispersion.

It should be remembered that the increase in flow rates in optical fibres means that phenomena need to be taken into account which until now were considered as negligible. This is the case of polarisation mode dispersion (PMD), especially in former generation fibres. We point out that by polarisation mode dispersion we mean that during the transmission, the optical pulses are doubled to two states of polarisation.

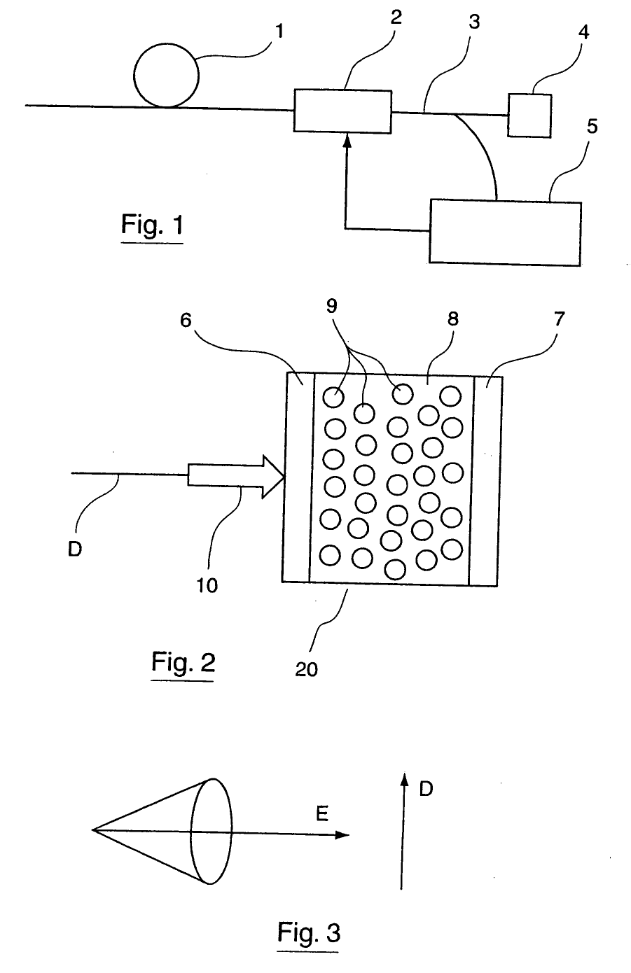

To compensate this dispersion, it is known that inserting in series, between the optical transmission fibre and the photo detector, a compensation system comprising a polarisation controller, a polarisation holding fibre and equipment for measuring the degree of polarisation on the polarisation holding fibre. In other words, and as illustrated in FIG. 1, the optical transmission fibre 1 is connected to the polarisation controller input 2, and the output of the latter is connected to one end of the polarisation holding fibre, 3, the other end of the latter is connected to the photo detector 4. This compensation system operates as follows: using suitable measuring means, 5, the degree of polarisation on the polarisation holding fibre is measured, so as to quantify the degree of polarisation, and the polarisation controller is modified in order to minimise the dispersion.

If we consider that the polarisation mode dispersion phenomenon becomes a problem from 10% of the bit time, a dispersion of 10 ps is the acceptable limit for a flow rate of 10 Gbit/s.

The compensation of the polarisation mode dispersion imposes demanding constraints on the polarisation controllers, i.e. rapid control (about 10 μs), dynamic and endless.

A first known technology of a polarisation controller, aiming to satisfy these constraints, is the Lithium Niobate (LiNbO₃) technology. It is described in detail in the document entitled “Endless polarisation control using integrated optic lithium niobate device”, Electron. Letters Vol. 24, pp 266-268, 1988, by N. Walker and G. Walker, JLT, Vol. 8 pp 438-458, 1990. It concerns integrated optic components on which electrodes in different positions on the guide allow TE/TM mode conversions to be alternated with phase offsets. Three independent potentials permit a dynamic endless controller to be made. This first technology has several disadvantages, in particular: high command voltages (over 100 Volts), a residual birefringence out of the field, insertion losses (typically 3-4 dB) and a high manufacturing cost.

A second known polarisation controller technology, which constitutes the other most serious option, consists of a classic combination of phase plates (two quarter wave and one half wave) with variable axes. In particular, we can refer to the article by Z. Zhuang et al. entitled “polarisation controller using nematic liquid crystal”, Optics Letters, Vol. 24, pp 694-696, 1999. Theoretically, a single phase plate with variable axis and phase offset is sufficient.

In this approach, liquid crystal (nematic or smectic) solutions are most often used as they have strong electro-optical effects on short distances and permit endless rotation of the director. In particular, we can refer to the article by T. Chiba et al. entitled “Polarisation stabiliser using liquid crystal rotatable waveplates”, JLT Vol. 17, pp 885-890, 1999.

The nematic liquid crystal solutions are unfortunately too slow now (about 10 ms).

Smectic liquid crystal solutions were therefore proposed. In particular, we can refer to the article by L. Dupont et al. entitled “Principle of polarisation mode dispersion controller using homeotropic electroclinic liquid crystal confined single mode fibre device”, Optics communications, Vol. 176, pp 113-119, 2000 and RNRT Copoldyn. We can also refer to the American patent no U.S. Pat. No. 5,313,562 by Marconi GEC Ltd. Entitled “Optical device with electrodes end to end with electric field causing homeotropic alignment of liquid crystal is space between ends”. The text of this article by Dupont and that of the American patent no U.S. Pat. No. 5,313,562 by Marconi GEC Ltd. Are inserted here for reference.

These smectic liquid crystal solutions have most of the time however, high alignment quality constraints (need to use alignment layers) and low modulation angles.

The aim of the invention in particular is to overcome these various disadvantages of the state of the technique.

More precisely, one of the objectives of this invention is to provide a polarisation controller permitting rapid control (several tens of microseconds), which is to say with very low switching times (also called reconfiguration times), compatible with the new high flow rates on optical fibres.

The aim of the invention is also to provide such a polarisation controller permitting dynamic endless control.

Another aim of the invention is to provide such a polarisation controller with a low manufacturing cost, especially in comparison with those manufactured using the previously mentioned known technologies.

Another aim of the invention is to provide such a polarisation controller that does not require an alignment layer.

These various aims, as well as others which will subsequently become clear, are achieved by the invention using a polarisation control device transported in the form of a luminous beam, the said device comprising:
a cell formed by two substrate plates essentially parallel to one another and between which are confined contents comprising a polymer in which droplets of liquid crystal are dispersed;
first application means, on at least part of the cell contents, of an electrical field more or less perpendicular to the direction of the spread of the luminous beam.
   so that, depending on whether the first electrical field is applied or not, at least part of the contents of the cell forms a birefringent or isotropic medium respectively.

Advantageously, the size of the droplets of liquid crystal is considerably smaller, and preferably in a ratio of one to ten, than the wave length of the luminous beam.

The general principle of the invention therefore consists of replacing, in the polarisation controller, the liquid crystal by a heterogeneous system composed of droplets of liquid crystal of small diameter dispersed in a polymer matrix. This heterogeneous system is called “nano PDLC” (Polymer Dispersed Liquid Crystal). In the classic PDLC heterogeneous system, the size of the droplets is comparable to the incident light wavelength, and there is the phenomenon of diffusion. Such a diffusion phenomenon does not exist with the nano PDLC heterogeneous system of the invention, due to the fact that the liquid crystal droplets are small compared to the wavelength.

The advantages of the nano PDLC are in particular: the ease of use, the absence of an orientation layer for the liquid crystal, the stability in time of the structure and the rapid response time.

Without an electrical field applied, there is a statistical distribution of the directing vector in the droplets. The wave spreading through the medium has a mean index between that of the liquid crystal and that of the polymer. In fact, the orientation of the directors inside the droplets is determined by the interactions between the polymer and the liquid crystal at the interface. These orientations are generally distributed randomly in the absence of an electrical field.

The application of an electrical field, perpendicularly to the direction of the spread, causes the reorientation of the liquid crystal droplets, which causes global modulation of the refringence (partial disappearance of the statistical character? In other words, the luminous beam sees a birefringent material.

It can be noted that if an electrical field is applied co-linearly to the direction of the spread of the light, there is a modulation of the index (refringence).

The invention is also based on a completely new and inventive configuration of the application of the electrical field. The electrical field is applied (more or less) perpendicularly to the direction of the spread of the light, so that the luminous beam sees a birefringent material.

It should be remembered, on the contrary, that in the classic configuration when using a PDLC cell, the electrical field is co-linear to the direction of the spread of the light. It causes a reorientation of the liquid crystal director in the droplets. The directing vector of the liquid crystal in the droplets tends to align itself to the electrical field applied, but statistically, the directions in each of the droplets are spread on a cone whose axis of symmetry is the field applied. The wave then sees a medium which remains isotropic, regardless of the field applied. Only the index of the material changes. Studies have shown that the evolution of the material index according to the electrical field applied, for high UV radiation strengths, respect the law: δn=αE², where α=5.10⁻⁵ μm²/V².

In comparison to the nematic liquid crystal solutions, the polarisation controller of the invention is much quicker.

Furthermore, it is of better quality and optically more homogeneous (no alignment problems for greater thicknesses, no alignment layers) than the smectic liquid crystal solutions (see article by Dupont and American patent no U.S. Pat. No. 5,313,562 previously mentioned). Furthermore, contrary to them, it has no problem of continuous voltage. Finally, it has switching times as low as the known smectic liquid crystal solutions.

Advantageously, the first means of applying the first electrical field comprise at least one pair of electrodes positioned in a plane more or less parallel to the substrate plates.

According to one advantageous characteristic, the first means of applying the first electrical field comprise several pairs of electrodes, permitting the electrical field applied to be orientated as desired.

Advantageously, the several pairs of electrodes are positioned in a star formation in order to apply a first electrical field in continuous rotation.

In a first advantageous embodiment of the invention, the first application means of the first electrical field comprise at least one pair of bi-dimensional electrodes created on one of the faces of one of the two plates.

Advantageously, the first means of application of the first electrical field comprise:
at least a first pair of bi-dimensional electrodes, created on the inside face, which is in contact with the contents of the cell, of one of the two plates.

At least a second pair of electrodes, created on the inside face, which is in contact with the contents of the cell, of the other of the two plates. and the said at least first and second pairs of bi-dimensional electrodes are complementary, so as to increase the depth of penetration of the first electrical field.

In a second advantageous embodiment of the invention, the first means of application of the first electrical field comprise at least one pair of tri-dimensional electrodes and have a thickness at least equal to at least a substantial part of the thickness of the cell contents.

In the first embodiment previously mentioned, with the bi-dimensional (which is to say thinner) electrodes, the depth of penetration of the electrical field in the thickness of the cell remains low and is not homogeneous. It is therefore difficult to obtain major phase offsets. The second previously mentioned embodiment with the tri-dimensional (which is to say thicker) electrodes, aims to overcome this disadvantage.

Preferably, the two substrate plates belong top the group comprising: plates of glass with optical fibre ends.

Advantageously, the amplitude of the first electrical field applied by the said first application means is predetermined, so as to obtain a predetermined birefringence modulation, dependent on the said first electrical field.

According to one advantageous variant, the said device comprises among others second application means, to the said at least one part of the cell contents, for a second electrical field whose amplitude is predetermined, so as to obtain a predetermined birefringence modulation, dependent on the sum of the said first and second electrical fields.

In one advantageous embodiment of the invention, the said device comprises means which permit the amplitude of the first and/or second electrical field to be modulated, so as to obtain a variable birefringence modulation.

The invention also concerns the application of the previously mentioned said polarisation control device for the use of a polarisation mode dispersion compensation system.

Other characteristics and advantages of the invention will become clear upon reading the following description of a preferential embodiment of the invention, provided by way of a non-restrictive example, and to the appended drawings, in which:

FIG. 1, already described, shows a simplified diagram of a polarisation mode dispersion compensation system, comprising a polarisation controller, a polarisation holding fibre and means for measuring the degree of polarisation on the polarisation holding fibre;

FIG. 2 shows a simplified diagram of a specific embodiment of the polarisation controller of the invention;

FIG. 3 illustrates the application of an electrical field perpendicularly to the direction of the spread of the luminous beam;

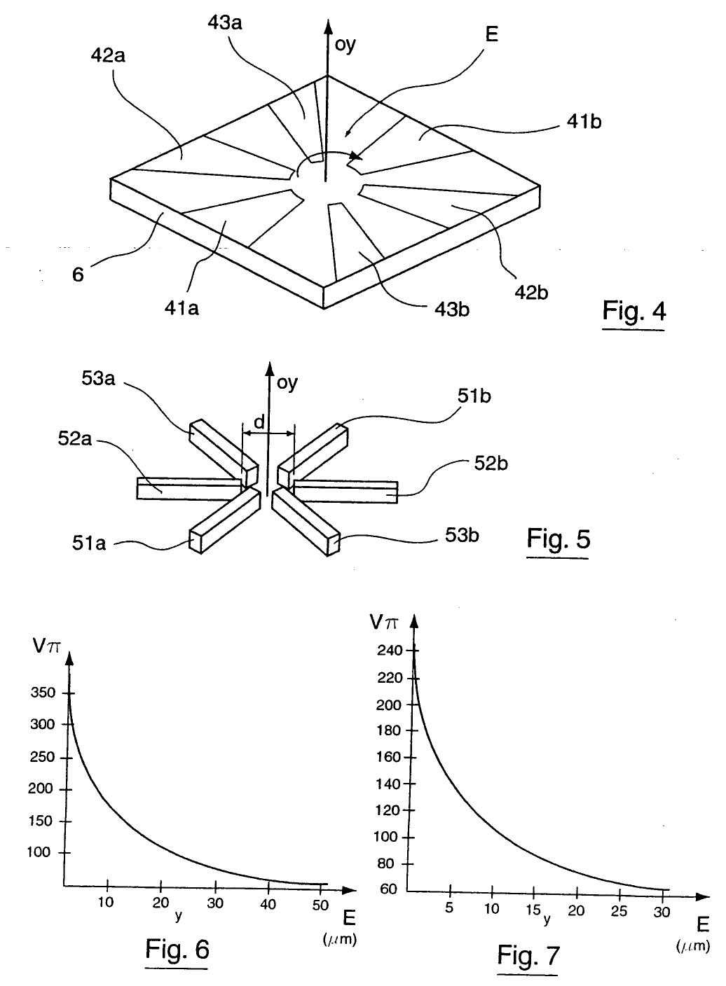

FIG. 4 shows a simplified diagram of a first embodiment of the (bi-dimensional) electrodes that are part of the polarisation controller of this invention;

FIG. 5 shows a simplified diagram of a second embodiment of the (tri-dimensional) electrodes that are part of the polarisation controller of this invention;

FIGS. 6 and 7 each show a graph representing the voltages required to obtain a phase offset of π according to the thickness of the cell included in the polarisation controller of this invention, for an inter-electrode space equal to 30 μm (FIG. 6) and 20 μm (FIG. 7) respectively.

The invention therefore concerns a polarisation controller which may be used in particular as part of a polarisation mode dispersion compensation system, as previously described in relation to FIG. 1.

As illustrated in the simplified diagram of FIG. 2, in a specific embodiment of the invention, the polarisation controller 20 comprises:
a cell composed of two glass plates 6 and 7 essentially parallel to one another and between which is confined a nano PDLC material. The latter comprises a polymer 8 in which liquid crystal droplets 9 are dispersed, the size of which (for example several tens of nanometres) is smaller, by a ratio of one to ten, than the wavelength of the luminous beam;
at least one pair of electrodes (see detailed discussion hereunder, in relation to FIGS. 4 and 5), permitting, to at least part of the cell contents, an electrical field E to be applied (see FIGS. 3 and 4) more or less perpendicularly to the direction D of the spread of the luminous beam 10.

The operating principle is as follows: depending on whether the electrical field is applied or not, at least part of the cell contents forms a birefringent or isotropic medium respectively.

When the electrical field is not applied, there is a statistical distribution of the directing vector in the droplets. The wave spreading through the nano PDLC medium sees an isotropic medium with a mean index between that of the mean liquid crystal on all of the droplets and that of the polymer. A phenomenonological expression provides the variation:
\overline{N}=x\overline{n}_{cl}(E)+(1−x)n_{polymer} (1)

Where x designates the relative proportion of the liquid crystal with respect to that of the polymer, and n_{cl}(E) designates the means liquid crystal index on all of the droplets, which depends on the electrical field E applied and which can be written:
\overline{n}_{cl}=(2n₀+nₑ)/3 (2)
where n₀ and nₑ are respectively the ordinary and extraordinary indices of the liquid crystal.

When the electrical field E is applied perpendicularly in the direction D of the spread of the luminous beam (as illustrated in FIG. 3), the wave spreading in the nano PDLC material sees a birefringent medium whose ordinary and extraordinary indices can be expressed as follows:
\overline{N}ₒ=x\overline{n}ₒ(E)+(1−x)n_{polymer} (3)
\overline{N}ₑ=x\overline{n}ₑ(E)+(1−x)n_{polymer} (4)

Measurements have shown that for voltages of the order of 20 V/μm, birefringences of the order of 0.01 were obtained for acceptable diffusion losses.

The graphs in FIGS. 6 and 7 resume the voltages required to obtain a phase offset of n according to the thickness of the nano PDLC material cell, for an inter-electrode space equal to 30 μm (FIG. 6) and 20 μm (FIG. 7) respectively. It is supposed that the maximum index variations are of the order of 0.013 for applied electrical fields of 20 V/μm. It can be seen that phase offsets may be obtained from small thicknesses. This is an important point as it allows a device without a collimation optic to be envisaged, the losses due to divergence of the beam remain very low (for example 0.1 dB for a classic mono mode optical fibre, and negligible for a stretched core optical fibre).

We will now present, in relation to FIGS. 4 and 5, two embodiments of electrodes included in the polarisation controller of this invention.

In both cases, we will adopt, for at least one of the two glass plates 6 and 7, a system of electrodes comprising several (three for example) pairs of electrodes positioned in a star formation in a plane more or less parallel to the glass plate in question. Among others, this system of electrodes has an axis of symmetry Oy orthogonal to the plate of glass in question. This axis of symmetry Oy is the same as the direction D in which the light spreads. Therefore, it is possible to apply the electrical field, whose orientation is completely controlled, and which can be rotated continuously and endlessly.

Among others, by applying a variable voltage between the electrodes of each pair of electrodes, a variable birefringence modulation can be achieved.

In the first embodiment, illustrated in FIG. 4, the system of electrodes of the glass plate referenced 6 comprises three pairs of bi-dimensional electrodes (41a, 41b), (42a, 42b), (43a, 43b). These electrodes are created on one of the faces of the glass plate, preferably on the inside face, which is in contact with the nano PDLC material contained in the cell. These electrodes can be obtained by photolithography either from a transparent conductor deposit (ITO), or from a metallic deposit. For example, the LIGA technology is used which includes a step of electrolytic growth. By applying offset phase voltages to each of the electrodes of a same pair of electrodes (for example those referenced 41a and 41b in FIG. 4), an electrical field E is generated parallel to the glass plate. The beam passing through the centre of the electrode system then sees a birefringent material.

The glass plates may both have complementary electrode systems, which permits the depth of penetration to be increased (along the Oy axis) of the electrical field.

In the second embodiment, illustrated in FIG. 5, the electrode system (common to the two glass plates) comprises three pairs of (“solid”) tri-dimensional electrodes (51a, 51b), (52a, 52b), (53a, 53b) that are thick (several tens of microns thick). These electrodes may be made of conductive materials (metals) or semi-conductors (silicon or other). They may be made either by substrate photolithography or by the use of micro-points.

The advantages of the polarisation controller of the invention are especially as follows:
the uniformity of the electrical field applied;
a double function of director axis rotation and index modulation by a single voltage command;
a simplified electronic interface;
sturdy mechanical structure;
efficient confinement of the material permitting the desired effect on thin layers of active component (10-15 μm);
a working pupil of several tens of μm (typically 30 μm) compatible with the use of mono mode fibres or stretched core mono modes or comprising an external collimation micro optic permitting the use of reasonable voltages. The nano PDLC is still sufficiently thin so that the optical beam from a fibre does not diverge when passing through the material.

In such a context, the specifications for the optical compensation device are:

| Parameters | Min. | Max. | Units |
|---|---|---|---|
| Insertion losses | | 3 | dB |
| PDL | | 0.2 | dB |
| PMD | | 0.2 | Ps |
| Max. power | | 10 | dBm |
| Response time | | 40 | μs |
| Insulation | 30 | | dB |
| Temperature | −5 | 70 | ° C. |

Optionally, the polarisation controller of this invention comprises:
apart from the first means already mentioned, permitting an electrical field to be applied perpendicularly to the direction in which the light spreads:
other (second) means of applying a second electrical field.

The birefringence modulation obtained depends in this case on the sum of the first and second electrical fields. Thus, by choosing suitable amplitudes for these two electrical fields, a predetermined birefringence modulation is obtained.

Moreover, if a variable birefringence modulation is desired, means can be provided which allow the first and/or the second electrical field to be applied with a variable amplitude.

1. Device for controlling the polarisation of a signal transported in the form of a luminous beam, wherein it comprises:
a cell composed of two substrate plates essentially parallel to one another and between which is confined a contents comprising a polymer in which droplets of liquid crystal are dispersed;
first application means, on at least part of the cell contents, of a first electrical field more or less perpendicular to the direction of the spread of the luminous beam,
such that, depending on whether the first electrical field is applied or not, at least part of the contents of the cell forms a birefringent or isotropic medium respectively.

2. Device of claim 1, wherein the liquid crystal droplets are considerably smaller in size to the wavelength of the luminous beam.

3. Device of claim 2, wherein the liquid crystal droplets are smaller in size to the wavelength of the luminous beam by a ratio of one to ten.

4. Device of claim 1, characterised in that the first application means of the first electrical field comprise at least one pair of electrodes positioned in a plane more or less parallel to the substrate plates.

5. Device of claim 1, wherein the first application means of the first electrical field comprise several pairs of electrodes permitting the electrical field applied to be orientated as desired.

6. Device of claim 5, wherein the several pairs of electrodes are positioned in a star formation, so that a first electrical field can be applied in rotation and continuously.

7. Device of claim 1, wherein the first application means of the first electrical field comprise at least one pair of bi-dimensional electrodes created on one of the faces of the two plates.

8. Device of claim 7, wherein the first application means of the first electrical field comprise:
at least a first pair of bi-dimensional electrodes created on the inside face that is in contact with the cell contents, of one of the two plates;
at least a second pair of bi-dimensional electrodes created on the inside face that is in contact with the cell contents, of the other of the two plates;
and in that the said at least first and second pair of bi-dimensional electrodes are complementary, so that they increase the depth of penetration of the first electrical field.

9. Device of claim 1, wherein the first application means of the first electrical field comprise at least one pair of tri-dimensional electrodes and have a thickness at least equal to a substantial part of the thickness of the cell contents.

10. Device of claim 1, wherein the two substrate plates belong to the group comprising: plates of glass with optical fibre ends.

11. Device of claim 1, wherein the amplitude of the first electrical field applied by the said first application means is predetermined, so as to obtain a predetermined birefringence modulation dependent on the said first electrical field.

12. Device of claim 1, wherein it comprises among others second application means, to the said at least one part of the cell contents, for a second electrical field whose amplitude is predetermined, so as to obtain a predetermined birefringence modulation, dependent on the sum of the said first and second electrical fields.

13. Device of claim 11, wherein it comprises means which permit the amplitude of the first electrical field and/or the second electrical field to be varied, so as to obtain a variable birefringence modulation.

14. Application of the polarisation control device according to claim 1 for the use of a system of compensation of the polarisation mode dispersion.
